(19) United States
(12) Patent Application Publication
(10) Pub. No.: US 2008/0193751 A1
(43) Pub. Date: Aug. 14, 2008

(54) Uv-Curing Adhesive, Preparation Process, Adhesively Bonded Semiconductor Component, and Method of Adhesive Bonding

(76) Inventor: Peter Groppel, Erlangen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/067,839

(22) PCT Filed: Sep. 26, 2006
(86) PCT No.: PCT/EP2006/066745

§ 371 Date: Mar. 28, 2008

(30) Foreign Application Priority Data
Sep. 28, 2005 (DE) 10 2005 046 439.4
Dec. 29, 2005 (DE) 10 2005 062 946.6

(51) Int. Cl. B32B 7/12; B32B 37/12; B32B 27/38; C08K 3/34; C09J 163/00

(52) U.S. Cl. 428/355 EP; 428/343; 156/273.3; 428/355 R; 524/445; 524/447

(57) ABSTRACT

A UV-curing adhesive has at least one UV-curable resin and a multiplicity of particles of organic clay material which have a high aspect ratio, based on a height with respect to a length of the particles.

### CROSS-REFERENCE TO RELATED APPLICATIONS

This application is a U.S. national stage application of International Application No. PCT/EP2006/066745 filed Sep. 26, 2006, which designates the United States of America, and claims priority to German application no. 10 2005 046 439.4 filed Sep. 28, 2005 and German application no. 10 2005 062 946.6 filed Dec. 29, 2005, the contents of which are hereby incorporated by reference in their entirety.

### TECHNICAL FIELD

The invention relates to a UV-curing adhesive comprising organic clay minerals for adhesive bonding and encapsulation of semiconductor components, to a method for preparing such an adhesive, to adhesively bonded or encapsulated semiconductor components, and to a method of adhesive bonding or encapsulation.

### BACKGROUND

In the assembly of semiconductor components, various parts of the semiconductor component frequently have to be bonded together using adhesive masses or encapsulated within what is known as “component packaging”. As increasing demands are made of semiconductor components, the requirements for such adhesive masses are also increasing. Adhesives are therefore expected not only to guarantee secure and fast bonding of the individual components, but they are expected furthermore to prevent the penetration of, for example, water, moisture and harmful gases in a reliable manner. In particular, this is of particular importance in the case of organic light-emitting diodes (OLEDs). Hereafter, the invention shall be described using OLEDs as an example but it is not restricted thereto. OLEDs comprise organic monomers or polymers which are disposed between electrodes, an electrode being transparent. When a voltage is applied to an electrode, the emission of light ensues. For this purpose, OLEDs typically have an organic electroluminescent material (emitter), an organic hole-transporting material and an organic electron-transporting material. These materials, together with the cathode material, have to be protected from degradation by air (oxygen) and water, for which purpose an efficient encapsulation or a housing is required.

Various encapsulations are described, for example, in EP 1 218 950 B1. They all have specific disadvantages, however, as is set out hereafter.

OLEDs are preferably surrounded by a glass housing, it being necessary for the glass components to be combined with one another. However, glass soldering, that is, the combining of glass components using a glass solder, has the disadvantage that the diode is heated, which can lead under certain circumstances to the destruction of the polymer materials.

The bonding of glass components, such as glass substrates, glass plates or glass encapsulations, using various, mostly heat-curing adhesives is also known. The adhesives used for this purpose all have the disadvantage, however, that the exclusion of moisture cannot be fully guaranteed. Therefore, “getter materials” are used in order to absorb and bind any moisture that seeps through. Since these materials become depleted as time passes, they lose their effectiveness in time, with the result that the OLED can no longer be protected against any moisture that seeps through.

EP 1 218 950 B1 also discloses an epoxy resin-adhesive. This adhesive is a UV-curable chemically reactive adhesive and does not require the adhesive to be heated for it to cure. However, it still has the disadvantage that the penetration of harmful gases and moisture cannot be prevented in a reliable manner. The published unexamined document US 2003/39812, on the other hand, discloses epoxy resins that are mixed with organic clay materials, “organoclays”, in order to reduce the permeability to harmful gases and moisture and to reduce the hygroscopic properties of the resin. The terms organophilic clay minerals or organic clay minerals denote clay minerals in which the alkali and earth alkali ions present in the layers are replaced by more bulky cations such as substituted ammonium ions. This is generally referred to as intercalation. This intercalation leads to an increase in the distance between the layers in the layered silicates. The layers can also be completely separated from one another in such a case (exfoliation).

The use of organic clay in plastics has been restricted hitherto to heat-curable plastics, however, since an extensive or complete exfoliation of the layered silicates is possible only by means of a slow curing process of the kind encountered with heat-curable plastics. Curing in UV-curable resins, however, is achieved within a few seconds. This time is not sufficient for the exfoliation of the clay minerals. Heat-curable plastics further have the disadvantage that the components that are to be bonded must be heated in order for the plastic to harden. In this way, damage can be caused to the sometimes sensitive components.

### SUMMARY

There is therefore a current need for an adhesive, in particular for sensitive semiconductor components such as OLEDs, which adhesive has improved protection against moisture and does not have to be heat-cured.

A UV-curable resin and a corresponding preparation method for the resin can thus be provided, wherein the resin has reduced permeability to water. Furthermore, a method for bonding materials and likewise an adhesively bonded material in which a UV-curable resin with reduced permeability to moisture is used as an adhesive can be provided.

According to various embodiments, a UV-curable adhesive may comprise at least one UV-curable resin and a plurality of particles of organic clay material which have a high aspect ratio, based on a height with respect to a length of the particles.

According to a further embodiment, the aspect ratio may be greater than 10, preferably greater than 100. According to a further embodiment, the UV-curable resin can be an epoxy resin or an aliphatic and/or a cycloaliphatic epoxy resin. According to a further embodiment, the adhesive may contain particles of natural and/or synthetic, intercalated and/or exfoliated layered compounds. According to a further embodiment, the natural and/or synthetic layered compounds may be selected from intercalated and/or exfoliated bentonite, hectorite, montmorillonite or hydrotalcite. According to a further embodiment, the adhesive additionally may contain a bonding agent and/or a photoinitiator and/or filler.

According to another embodiment, a method for preparing a UV-curable adhesive comprising a plurality of particles of organic clay material which have a high aspect ratio, based on a height with respect to a length of the particles, may comprise the steps of: (a) preparing a resin; (b) dispersing an organic clay material in the resin; (c) swelling of the organic clay in the resin for a predetermined period of time; (d) homogeneous mixing of the swollen mixture.

According to a further embodiment, the swelling can be carried out for a period of 1 to 20 hours or from 4 to 12 hours. According to a further embodiment, the swelling can be carried out at a temperature in the range of 20 to 120° C., or in the range of 40 to 100° C.

According to yet another embodiment, a semiconductor component may comprise a substrate and may comprise a semi-conductor structure, which is incorporated in the substrate or applied on a surface of the substrate, may comprise a housing to protect the semi-conductor structure and may comprise an adhesive comprising at least one UV-curable resin and a plurality of particles of organic clay material which have a high aspect ratio, based on a height with respect to a length of the particles.

According to a further embodiment, the adhesive at least partially may forms the housing. According to a further embodiment, the housing may be configured as an encapsulation and the adhesive may bond the housing to the substrate. According to a further embodiment, the semi-conductor structure may comprise at least one OLED.

According to yet another embodiment, a method for the bonding of substrates may comprise the steps of (A) preparing a first substrate; (B) applying to the substrate of an adhesive comprising at least one UV-curable resin and a plurality of particles of organic clay material which have a high aspect ratio, based on a height with respect to a length of the particles; (C) applying a second substrate to the first substrate; and (D) curing of the adhesive using UV light.

### BRIEF DESCRIPTION OF THE DRAWINGS

The invention is described hereafter in more detail with reference to exemplary embodiments and with reference to the schematic figures in the drawing, in which;

FIG. 1 shows a cross-sectional view of an encapsulated OLED;

FIG. 2 shows a cross-sectional view of a power component encapsulated with an adhesive.

### DETAILED DESCRIPTION

According to a first aspect, a UV-curing adhesive is provided, containing at least one UV-curable resin and a plurality of particles of organic clay material which have a high aspect ratio, based on a height with respect to a length of the particles.

According to a further aspect, a method for the preparation of a UV-cured resin is provided, which resin contains a plurality of particles of organic clay material which has a high aspect ratio, based on a height with respect to a length of a particle, comprising the steps:
(a) preparation of a resin;
(b) dispersing of an organic clay material in the resin;
(c) swelling of the organic clay in the resin for a predetermined period of time;
(d) homogeneous mixing of the swollen mixture.

According to yet another aspect, a semiconductor component is provided, comprising a substrate and comprising a semi-conductor structure that is incorporated in the substrate or applied onto a surface of the substrate, comprising a housing to protect the semi-conductor structure and comprising an adhesive according to any of claims 1-6.

According to a fourth aspect, a method for the bonding of substrates is provided, comprising the following steps:
(A) preparation of a first substrate;
(B) application onto the substrate of an adhesive according to any of claims 1-6;
(C) application of a second substrate onto the first substrate;
(D) curing of at least the adhesive using UV light.

An adhesive can be rendered impermeable to moisture or water and/or harmful gases by incorporating intercalated or exfoliated organic clay material. A method of exfoliating the clay minerals in the adhesive before curing was developed. Such an adhesive, which already contains exfoliated clay minerals, has a reduced permeability to moisture or harmful gases and is not detrimental to heat-sensitive components, since curing is achieved by UV irradiation. Moreover, the adhesive has good storage properties. Since at least one dimension of the particles is in the nanometer range, they exhibit no or no substantial diffusion of light and thus do not adversely affect the adhesive in terms of light permeability. The adhesives can be prepared without solvents and are thus very environment-friendly. The reduction in the filled volume of inorganic material compared with conventional fillers improves bonding on the substrate surfaces. This likewise results in a reduction in mechanical stresses and in the modulus of elasticity, something which reduces the formation and spread of cracks.

The exfoliated clay minerals that are dispersed in the adhesive have an aspect ratio of greater than 10, preferably greater than 100, even more preferably greater than 1000. An exfoliated clay mineral particle is therefore distinguished by its very variable dimensions. Typically, these particles have a height of a few nanometers. On the other hand, the width and the length of the particles can be in the micrometer range. To determine the size of a particle, the height, width and length thereof are therefore used, the height being the shortest and the length being the longest dimension. Particles are equivalent to individual crystal lamellae.

The resin used as a UV-curable or UV-curing resin is preferably an epoxy resin. Said epoxy resin can be an aliphatic and/or cycloaliphatic epoxy resin. The use of bisphenol A diglycidyl ether as an epoxy resin has proved to be particularly advantageous. However, other known epoxy resins and also other thermosets can be used.

The organic clay minerals that make up the particles can be obtained from natural and/or synthetic clay minerals. These can be prepared by intercalation and/or exfoliation.

Intercalation involves the alkali and/or earth alkali ions, located between the crystal layers, being exchanged for suitable ammonium compounds and/or carboxylic acids. During this process, the layered compounds are rendered organophilic and therefore plastics-compatible. The layered compounds prepared in this way are known as organoclays.

Bentonite, hectorite, montmorillonite and/or hydrotalcite are preferably used as the organic clay material. Preferably, the adhesive additionally contains further substances. These can be, for example, bonding agents, photoinitiators and/or fillers. Bonding agents can be silane-based, for example. In particular, alkoxy-functional silanes, which are generally methoxy- and ethoxy-functional silanes, can be used advantageously. Silanes usually have at least one further group bonded thereto by an Si—C-bond, as is the case, for example, with glycidyl oxypropyl trimethoxysilane. The bonding agent can be added to the adhesive preferably in an amount of 0.05 to 2 weight %. An onium salt, in particular a triaryl sulfonium salt with hexafluorophosphate, hexafluoroarsenate or hexafluo-roantimonate as anion, such as for example, triphenyl sulfonium hexafluoroantimonate, is preferably used as the photoinitiator. The photoinitiator is added preferably in a proportion of 0.01 to 5 weight %. Furthermore, fillers can be incorporated. Said fillers can be used for adapting the flow properties, for example. Suitable fillers are quartz flours or other mineral-based fine flours, in particular containing silicic acid. In addition, further known additives can be added. Said additives can include, for example, dyes, pigments, wetting agents, dispersing agents, bonding agents, thixotroping agents, defoamers, flow modifiers, stabilizers and flame retardants. As a result thereof, the adhesive can be endowed with additional properties, such as color, specific rheological properties and flame resistance. The adhesive can also additionally contain a polyol. Polyols have the function of modifying the mechanical properties of the hardened adhesive and are used, depending on their molecular weight and OH content, in an amount such that there is no excess of OH groups or epoxy groups. Furthermore, the chemically reactive adhesive can additionally contain a surface-active compound, in particular a surface-active siloxane. Such additives serve as defoamers and dispersing agents. The proportion of surface-active compounds is low. It is generally only 0.1 to 0.5 weight %.

The method for preparing a UV-curable resin includes the dispersing of the organoclay in the resin. The organoclay is subsequently exfoliated in a swelling phase of the organoclay. Swelling can be carried out at a temperature in the range 20-120° C., preferably in the range 40-100° C. Swelling takes from 1 to 10 hours, preferably from 4 to 12 hours. The mixture is then homogenized once again, it being possible to add further substances, such as, for example, a UV hardener or photoinitiator.

The adhesive can be used advantageously in a plurality of embodiments to encapsulate semiconductor components. For example, the adhesive can be used for adhesively bonding an encapsulation to a substrate or as an encapsulation itself. Use thereof is possible in every case where adhesive bonding properties are necessary together with an air- or gas-tight seal. Therefore, the adhesives according to various embodiments can be used preferably for the encapsulation of OLEDs.

In order to adhesively bond substrates, the adhesive is applied to at least one surface of at least one of the parts of the substrate. After the surfaces have been brought together and aligned, the UV curable adhesive is hardened by irradiation with UV light. Here, light in the absorption maximum or close to the absorption maximum of the UV photoinitiator is preferably used. It is also possible, however, to use light in the absorption maximum of the UV-curable resin itself, as long as this absorbs in the ultraviolet range. Wavelengths shorter than 400 nm are used for this purpose.

The invention is described hereafter in greater detail with reference to the exemplary embodiments.

For the preparation of epoxy resin-nanocomposites, the synthetic bentonite EXM 857 from the company Suid-Chemie AG, Moosburg, was used as a nanocomposite filler (organoclay). An ammonium cation is contained as an organic modification in this product. Epoxy resin-bentonite mixtures were prepared using various EXM 857 concentrations as follows.

The filler was first prepared in the desired concentration with the aid of a dispersing device into 100 parts by weight of a bisphenol A diglycidyl ether resin. After an 8-hour swelling phase at a temperature of 80° C., 3 parts by weight of UVI 6974 from the company UCC (Union Carbide Chemicals) were added to the mixture after cooling, as a UV hardener. The mixture was then stirred for a further 15 minutes at room temperature, deaerated and then applied by screen printing onto a substrate surface, in a layer thickness of about 0.25 mm.

Hardening ensues under a commercially obtainable UV lamp from the Hönle company by irradiation for a period of 30 seconds.

Various formulations were prepared.

### Sample 1:

Preparation as described above.

### Formulation:

5 parts by weight organoclays (EXM 857)

100 parts by weight bisphenol A diglycidyl ether (EP 0162)

3 parts by weight UV hardener (UVI 6974)

### Sample 2:

Preparation as described above.

### Formulation:

10 parts by weight organoclays (EXM 857)

100 parts by weight bisphenol A diglycidyl ether (EP 0162;

3 parts by weight UV hardener (UVI 6974)

### Sample 3:

Preparation as described above.

### Formulation:

10 parts by weight organoclays (EXM 857)

100 parts by weight bisphenol A diglycidyl ether (EP 0162)

10 parts by weight modified bisphenol A diglycidyl ether (77-02, from the company Leuna-Harze)

3 parts by weight UV hardener (UVI 6974)

### Sample 4:

Preparation as described above. Formulation:

10 parts by weight organoclays (EXM 857)

100 parts by weight bisphenol A diglycidyl ether (EP 0162)

10 parts by weight epoxy phenol-novolak (DEN 438, Dow Chemical)

3 parts by weight UV hardener (UVI 6974)

The water vapor permeability (WVP) of the epoxy resin nanocomposite cured resins was determined using a Ca-sensor. In this method, a Ca sensor with a thickness of about 1 μm is deposited in a glass cavity. A glass lid is glued thereon. The epoxy resin nanocomposite according to an embodiment is used as an adhesive. Diffusion ensues through the adhesive layer. As moisture is allowed in, the degradation of the calcium sensor, when stored in an environment of 70° C. und 90% relative humidity, is used as a parameter to measure diffusion. The results of the studies are shown in Table 1.

TABLE 1
Time required for the Ca sensor to degrade, as a
measure of water vapor permeability.

| | Reference | Sample 1 | Sample 2 | Sample 3 | Sample 4 |
|---|---|---|---|---|---|
| Time (h) | 60 | 700 | 100 | 1200 | 1400 |

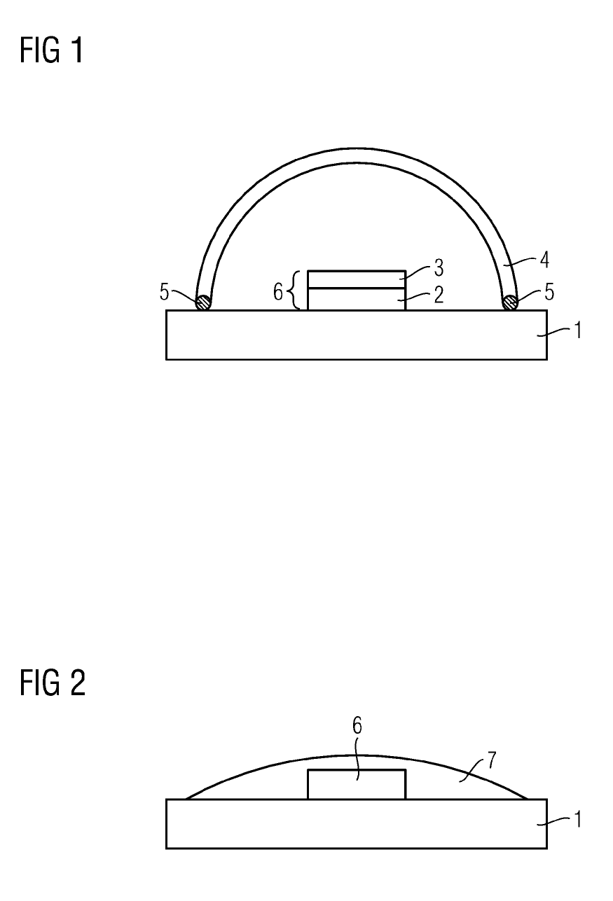

As can be seen from the comparative example, the water vapor permeability of the samples produced according to an embodiment is superior to that of the comparative example. FIG. 1 shows a cross-sectional view of an encapsulated OLED, in which two layers 2 and 3 are applied onto a substrate 1 to form the OLED. The two layers are surrounded by an encapsulation 4. Said encapsulation 4 is bonded to the substrate by means of an adhesive 5.

In order to produce such an encapsulated OLED, the two organic layers 2, 3 are applied to the substrate 1 in order to create the OLED. In order to encapsulate the arrangement, an adhesive 5 is applied to the area of contact of the encapsulation 4 with the substrate 1. The encapsulation 4 with the adhesive 5 applied thereto is placed onto the substrate 1 such that the OLED is encapsulated by the encapsulation 4.

FIG. 2 shows a cross-sectional view of a power component 6 that has been encapsulated with an adhesive. The adhesive 7 is cast over a power component 6 that has been applied onto a substrate 1, as a result of which said component becomes encapsulated. The power component can be a MOSFET, a JFET or a thyristor, for example.

Although the present invention has been described in the aforementioned with reference to a preferred exemplary embodiment, it is not restricted thereto but can be modified in a variety of ways. Thus the invention is not restricted to the specific design of an OLED shown in the above figure. The adhesive can also be used in fact for the encapsulation of other semiconductor components.

What is claimed is:

1. A UV-curable adhesive comprising at least one UV-curable resin and a plurality of particles of organic clay material which have a high aspect ratio, based on a height with respect to a length of the particles.

2. The adhesive according to claim 1, wherein the aspect ratio is greater than 10 or greater than 100.

3. The adhesive according to claim 1, wherein the UV-curable resin is an epoxy resin, an aliphatic and/or a cycloaliphatic epoxy resin.

4. The adhesive according to claim 1, wherein the adhesive contains particles of natural and/or synthetic, intercalated and/or exfoliated layered compounds.

5. The adhesive according to claim 4, wherein the natural and/or synthetic layered compounds are selected from intercalated and/or exfoliated bentonite, hectorite, montmorillonite or hydrotalcite.

6. The adhesive according to claim 1, wherein the adhesive additionally contains a bonding agent and/or a photoinitiator and/or filler.

7. A method for preparing a UV-curable adhesive comprising a plurality of particles of organic clay material which have a high aspect ratio, based on a height with respect to a length of the particles, the method comprising the steps of:
(a) preparing a resin;
(b) dispersing an organic clay material in the resin;
(c) swelling of the organic clay in the resin for a predetermined period of time;
(d) homogeneous mixing of the swollen mixture.

8. The method according to claim 7, wherein the swelling is a carried out for a period of 1 to 20 hours or from 4 to 12 hours.

9. The method according to claim 7, wherein the swelling is carried out at a temperature in the range of 20 to 120° C., or in the range of 40 to 100° C.

10. A semiconductor component comprising a substrate and comprising a semi-conductor structure, which is incorporated in the substrate or applied on a surface of the substrate, comprising a housing to protect the semi-conductor structure and comprising an adhesive comprising at least one UV-curable resin and a plurality of particles of organic clay material which have a high aspect ratio, based on a height with respect to a length of the particles.

11. The semiconductor component according to claim 10, wherein the adhesive at least partially forms the housing.

12. The semiconductor component according to claim 10, wherein the housing is configured as an encapsulation and that the adhesive bonds the housing to the substrate.

13. The semiconductor component according to claim 10, wherein the semi-conductor structure comprises at least one OLED.

14. A method for the bonding of substrates comprising the steps:
(A) preparing a first substrate;
(B) applying to the substrate of an adhesive comprising at least one UV-curable resin and a plurality of particles of organic clay material which have a high aspect ratio, based on a height with respect to a length of the particles;
(C) applying a second substrate to the first substrate;
(D) curing of the adhesive using UV light.

15. The method according to claim 14, wherein the aspect ratio is greater than 10 or greater than 100.

16. The method according to claim 14, wherein the UV-curable resin is an epoxy resin or an aliphatic and/or a cycloaliphatic epoxy resin.

17. The method according to claim 14, wherein the adhesive contains particles of natural and/or synthetic, intercalated and/or exfoliated layered compounds.

18. The method according to claim 17, wherein the natural and/or synthetic layered compounds are selected from intercalated and/or exfoliated bentonite, hectorite, montmorillonite or hydrotalcite.

19. The method according to claim 14, wherein the adhesive additionally contains a bonding agent and/or a photoinitiator and/or filler.

20. The semiconductor component according to claim 10, wherein the aspect ratio is greater than 10 or greater than 100.

21. The semiconductor component according to claim 10, wherein the UV-curable resin is an epoxy resin or an aliphatic and/or a cycloaliphatic epoxy resin.

22. The semiconductor component according to claim 10, wherein the adhesive contains particles of natural and/or synthetic, intercalated and/or exfoliated layered compounds.

23. The semiconductor component according to claim 22, wherein the natural and/or synthetic layered compounds are selected from intercalated and/or exfoliated bentonite, hectorite, montmorillonite or hydrotalcite.

24. The semiconductor component according to claim 10, wherein the adhesive additionally contains a bonding agent and/or a photoinitiator and/or filler.
